(19) United States
(12) Patent Application Publication
(10) Pub. No.: US 2025/0008952 A1
(43) Pub. Date: Jan. 9, 2025

(54) CHOLINE-BETAINE BASED ADJUVANTS FOR HERBICIDES

(71) Applicant: SPECIALTY OPERATIONS FRANCE, Lyon (FR)

(72) Inventor: Oleksandra Zavgorodnya, Bristol, PA (US)

(73) Assignee: SPECIALTY OPERATIONS FRANCE, Lyon (FR)

(21) Appl. No.: 18/710,858

(22) PCT Filed: Nov. 16, 2022
(86) PCT No.: PCT/US2022/050139

§ 371 Date: May 16, 2024

Related U.S. Application Data
(60) Provisional application No. 63/279,896, filed on Nov. 16, 2021.

(51) Int. Cl. A01N 25/30; A01N 37/40; A01N 57/20; A01P 13/00

(52) U.S. Cl. CPC A01N 25/30; A01N 37/40; A01N 57/20; A01P 13/00

(57) ABSTRACT

An agricultural adjuvant composition for pesticides may include at least one betaine compound and choline chloride, wherein a ratio of the at least one betaine compound relative to the choline chloride ranges from 1:8 to 8:1. The agricultural adjuvant composition may be used to form an adjuvated herbicide composition. The adjuvated herbicide composition may additionally include an effective amount of an agrochemical active ingredient. The agricultural adjuvant composition may increase the penetration of the agrochemical active ingredient into a plant.

### CROSS-REFERENCE TO RELATED APPLICATIONS

This application claims priority to U.S. Patent Application No. 63/279,896 filed on Nov. 16, 2021, which is herein incorporated by reference in its entirety.

### BACKGROUND

Many agricultural pesticides, including insecticides, fungicides, herbicides, miticides, and plant growth regulators, are applied in the form of a liquid composition. In addition to the pesticide, such liquid compositions typically include one or more adjuvant compounds intended to improve one or more properties of the liquid composition, such as for example, storage stability, ease of handling, and/or pesticide efficacy against target organisms. Pesticides may be sprayed from the air and because of wind, they could be carried to adjacent fields/roads and cause unwanted damage. Adjuvant compounds are also added to mitigate undesired side effects.

It is generally known that many agrochemical active compounds have to penetrate into the plant to be able to unfold their activity evenly throughout the plant. Thus, when the active compound is taken up via the leaves, the active compounds have to overcome the penetration barrier of the cuticle. Moreover, it is important that the agrochemical active compounds penetrate rapidly, distributed over a surface which is as large as possible, into the plant, since there may otherwise be the risk that the active components are washed off by rain.

Herbicides formulations can be systemic or contact. Systemic herbicides move throughout the plant, even when applied to one part. They are useful in controlling perennial weeds. Herbicides can move to the underground roots/stems for total control. Of all the systemic herbicides used in agriculture to combat weeds, one of the most used is N-phosphomethylglycine, better known as glyphosate. Another example of a systemic herbicide is dicamba.

Contact herbicides only work on the plant parts that they touch. They require good coverage to be effective. Most are non-selective and affect nearly every plant they are in contact with. Glufosinates are a class of non-selective contact herbicides with minimal systemic action.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more aspect, embodiments disclosed herein relate to an agricultural adjuvant composition for herbicides that includes at least one betaine compound and choline chloride, wherein a ratio of the at least one betaine compound relative to the choline chloride ranges from 1:8 to 8:1.

In another aspect, embodiments disclosed herein relate to an adjuvated herbicide composition that includes an agricultural adjuvant composition and an effective amount of an agrochemical active ingredient. The agricultural adjuvant composition includes at least one betaine compound and choline chloride, wherein a ratio of the at least one betaine compound relative to the choline chloride ranges from 1:8 to 8:1, and increases the penetration of the agrochemical active ingredient into a plant.

In yet another aspect, embodiments disclosed herein relate to a method for treating a plant including applying onto the plant an adjuvated herbicide composition that includes an agricultural adjuvant composition and an effective amount of an agrochemical active ingredient. The agricultural adjuvant composition includes at least one betaine compound and choline chloride, wherein a ratio of the at least one betaine compound relative to the choline chloride ranges from 1:8 to 8:1, and increases the penetration of the agrochemical active ingredient into the plant.

In yet another aspect, embodiments disclosed herein relate to a method for increasing the penetration of agrochemical active ingredient into a plant that includes mixing an agricultural adjuvant composition includes at least one betaine compound and choline chloride, wherein a ratio of the at least one betaine compound relative to the choline chloride ranges from 1:8 to 8:1, with at least one agrochemical active ingredient to form an adjuvated herbicide composition that includes the at least one agrochemical active ingredient and the agricultural adjuvant composition, which increases the penetration of the agrochemical active ingredient into a plant.

### BRIEF DESCRIPTION OF DRAWINGS

FIG. 1 shows penetration depth of different use rates of active ingredient with and without an agricultural adjuvant.

FIG. 2 shows penetration depth of an active ingredient for different adjuvant compositions.

FIG. 3 shows viscosity of an adjuvant composition at different temperatures over a period of time.

FIG. 4 shows the pH of an adjuvant composition at different temperatures over a period of time.

FIG. 5 shows penetration depth of an active ingredient for different built-in formulations.

FIG. 6 shows penetration depth of an active ingredient with and without an agricultural adjuvant.

FIG. 7 shows % weed control from day 1 to 28 after the application an active ingredient with and without an agricultural adjuvant.

FIG. 8 shows pictures of Velvetleaf plants of an untreated control, a plant treated with an active ingredient, and a plant treated with an active ingredient with an agricultural adjuvant after 21 days from the application.

### DETAILED DESCRIPTION

The present disclosure generally relates to an agricultural adjuvant composition provided to increase the penetration depth of an agricultural active ingredient, such as for example, glyphosate, glufosinate, and dicamba herbicides, as well as to herbicide compositions containing such adjuvant compositions. The agricultural adjuvant composition may include a mixture of betaines and choline chloride. The agricultural adjuvant composition may be used with various agrochemical active ingredients at an effective amount to form an adjuvated herbicide. The agricultural adjuvant composition may increase the penetration depth of the agricultural active ingredient into a plant.

As used herein “agricultural adjuvant” refers to a compound or composition which improves the effect or activity of the agrochemical active ingredient while having no phytotoxicity or activity when used alone. In the present embodiments, such a compound or composition may also be named “penetration enhancer”. The term penetration enhancer is understood as meaning compounds which accelerate the uptake of agrochemicals through the cuticle of a plant into the plant, i.e. the rate of uptake, and/or increase the amount of active substance absorbed into the plant, thus making it possible for the agrochemicals to become effective.

As used herein “agrochemical active ingredient” refers to a pesticide, such as an herbicide. Formulations in accordance with the present disclosure may include one agrochemical active ingredient or a mixture of agrochemical active ingredients.

As used herein “effective amount” refers to the relative amount of a agrochemical active ingredient in a composition that is effective to control the growth of a target organism, for example a target plant, when the composition is applied to the organism at a given application rate.

As used herein “adjuvated herbicide” refers to a formulation that includes both the agricultural adjuvant and at least one agrochemical active ingredient such as an herbicide. Such adjuvated herbicide compositions may include those that are tank-mixed (combined immediately prior to application onto a plant) or built-in (pre-formulated together).

### Agricultural Adjuvant Composition

The agricultural adjuvant composition in the present disclosure may include one or several betaine surfactants, choline chloride, and optionally a wetting agent and/or hydration control agent. In particular embodiments, the agricultural adjuvant composition may consist essentially of, or even consist of, the one or several betaine surfactants, choline chloride, and optionally a wetting agent and/or hydration control agent. In one or more embodiments, no more than 30 wt % of the adjuvant composition is a component other than betaines, choline chloride, and water. In one or more embodiments, the adjuvant composition includes no more than 25, 20, 15, 10, 5, 2.5, 1, or 0.5 wt % of components other than betaines, choline chloride, and water.

### Mixture of Betaines

The agricultural adjuvant composition in the present disclosure may include betaine surfactants, specifically a mixture of two or more betaine surfactants comprising at least two carboxy betaines.

In one or more embodiments, the betaine surfactants may be chosen from betaines having formula (I) or (II):

R¹R²R²N⁺—CH₂COO⁻ (I)

R¹—CO—NH—R⁴—R²R²N⁺—CH₂COO⁻ (II),

and mixtures thereof, wherein R¹ is a linear or branched hydrocarbon group, such as an alkyl group containing 2 to 30 carbon atoms, or 4 to 24 carbon atoms, or even 6 to 20 carbon atoms; R², which may be identical or different from each other, is a C1-C3 alkyl group, such as a methyl group; and R⁴ is a divalent linear or branched hydrocarbon group containing 1 to 6 carbon atoms, optionally substituted with a hydroxyl group, such as a group of formula —CH₂—CH₂—CH₂— or —CH₂—CHOH—CH₂—. Betaines of formula (I) are often referred to as alkyl betaines, and in particular embodiments may be an alkyldimethyl betaine based surfactant. Betaines of formula (II) are often referred to as alkyl amidoalkyl betaines.

In particular embodiments of formulae (I) and (II), R² is a methyl group, R¹ is a mixture of different groups having different numbers of carbon atoms, being linear or branched, and optionally having some insaturations, and R⁴, if present, is —CH₂ CH₂—CH₂—.

In one or more particular embodiments, R¹ is a lauryl alkyl group mixture having more than 50% by weight of C₁₂. In one or more embodiments, the betaine surfactant is a mixture of lauryl betaine and myristyl betaine.

### Choline Chloride

The agricultural adjuvant composition in the present disclosure may comprise choline chloride. Choline chloride is an organic compound and a quaternary ammonium salt formed from a choline cation with chloride anion.

In one or more embodiments, choline chloride may be formulated in water. In one or more embodiments, the choline chloride may be used in solution form, having a concentration of a lower limit of one of 55, 60, or 65 w/w % and an upper limit of 70, 75, 80 w/w % in water. In yet another embodiment, choline chloride may be a powder with a purity of above 95%.

In one or more embodiments, the weight ratio of the mixture of betaines to choline chloride in the agricultural adjuvant composition of the present disclosure may be in a range having a lower limit of any of 1:8, 1:4, 1:2, or 1:1 to an upper limit of any of 1:1, 2:1, 4:1, or 8:1, where any lower limit can be used in combination with any upper limit.

In one or more embodiments, the total amount of the mixture of betaines and choline chloride in the adjuvant composition at the specified ratio may be in a range from about 70 wt % to about 100 wt %.

### Wetting Agents

The agricultural adjuvant composition in accordance with the present disclosure may optionally include a wetting agent, in a range from 0 to 25 wt %. The wetting agent may be one or more surfactants from alkyl ether sulfates, sulfonates, sulfosuccinates, alkyl ether carboxylates, alkoxylated fatty acid, amine oxide, and alkoxylated alcohols. In particular embodiments, the wetting agent is an alkyl ether sulfate, such as of formula R—(OCH₂CH₂)ₙOSO₃M, where R is an alkyl having 6 to 22 carbons, and n ranges from 1 to 6. An example of such wetting agent is sodium lauryl ether sulfate. The wetting agent may be present in an amount ranging from a lower limit of one of 0, 5, and 10 wt % and an upper limit of one of 15, 20, 25 wt %.

### Hydration Control/Water Conditioning

The agricultural adjuvant composition in the present disclosure may optionally contain a hydration control agent. For example, ammonium containing compounds such as ammonium sulfate (AMS), diammonium phosphate (DAP), and urea ammonium nitrate (UAN), among others, are conventionally used to control polysaccharide hydration as well as in water conditioning. Ammonium containing compounds may help overcome the antagonistic effect of sodium, calcium and magnesium ions from hard water. Further, ammonium ions from ammonium sulfate may increase herbicide absorption. The mixture of surfactant(s) and ammonium sulfate is often a beneficial combination that increases efficacy of herbicides, mainly glyphosate and other weak acid herbicides. Both a surfactant and ammonium sulfate usually are required to maximize efficacy of herbicides.

In one or more embodiments, ammonium containing compounds may be present at an amount ranging from less than 3% by weight, or less than 2.5% by weight. It is also envisioned that in one or more embodiments, hydration control agents such as ammonium sulfate (AMS), diammonium phosphate (DAP), and urea ammonium nitrate (UAN) may be omitted from the agricultural adjuvant composition (and adjuvated herbicide composition).

Other examples of hydration control agents in one or more embodiments may include glycerol, propylene glycol, and polyethylene glycol.

### Adjuvated Herbicide Composition

As mentioned above, the agricultural adjuvant improves the effect or activity of an agrochemical active ingredient, and in particular accelerates the uptake of agrochemicals through the cuticle of a plant into the plant, i.e. the rate of uptake, and/or increase the amount of active substance absorbed into the plant. Upon combining the agricultural adjuvant composition with an agricultural active ingredient, specifically an herbicide, the formulation is referred to as an adjuvated herbicide composition. In accordance with the present disclosure, the adjuvated herbicide composition may be either a tank-mixed formulation or a built-in formulation.

Thus, the adjuvated herbicide composition of the present disclosure may include the agricultural adjuvant composition comprising of a mixture of betaines and choline chloride and at least one agrochemical active ingredient.

While the adjuvant composition has a majority composition of the betaines and choline chloride (present at the ratio described above), the adjuvant composition is present as a minority component within the adjuvated herbicide composition. Thus, in embodiments involving a built-in formulation, the adjuvant composition (i.e., betaines and choline chloride) may be present in the adjuvated herbicide composition at the ratios specified above in an amount ranging from a lower limit of any of 0.01, 0.05, 0.1, 0.5, 0.75, or 1 wt % to an upper limit of any of 1, 2, 3, 5, or 10 wt %, where any lower limit can be used in combination with any upper limit. On the other hand, when the adjuvant is tank-mixed with the herbicide to produce the adjuvated herbicide, the concentration of the adjuvant, as well as the active ingredient, are lower based on the dilution of the formulation for immediate application onto plants, as described below.

In one or more embodiments, the agrochemical active ingredient is an herbicide selected from aminophosphate or aminophosphonate salts and dicamba. Examples of aminophosphate or aminophosphonate salts include glyphosate or glufosinate salts.

Glufosinate refers to 4-[hydroxy(methyl)phosphinoyl]-DL-homoalanine. The glufosinate salts for herbicidal applications may include sodium (Na) salts, potassium (K) salts, ammonium salts having N(R)₄⁺ cations wherein R groups, identical or different, represent a hydrogen atom or a linear or non linear, saturated or unsaturated C₁-C₆ hydrocarbon group, optionally substituted by a hydroxyl group, for example isopropylamine salts, or sulphonium salts; the salts being present alone or in a combination.

Ammonium salts that may in particular be cited include salts obtained from secondary or primary amines such as isopropylamine (IPA), dimethylamine, diamines such as ethylenediamine, or alkanolamines such as monoethanolamine (MEA). Sulphonium salts may include, for example, trimethylsulphonium

Glyphosate refers to N-(phosphonomethyl)glycine. The glyphosate salts for herbicidal applications may include glyphosate potassium (K) salt, glyphosate sodium (Na) salt, isopropylamine (IPA) salt, monoethanolamine (MEA) salt, trimethylsulphonium salt, potassium salt, ammonium (NH₃) salt, and mixtures or associations thereof.

Dicamba refers to 3,6-dichloro-2-methoxybenzoic acid and is a chlorinated derivative of o-anisic acid. The dicamba salts for herbicidal applications may include one or more water soluble salts or esters.

Adjuvated herbicide composition in accordance with the present disclosure may include an herbicide, in a range from 16 to 30 wt %. The herbicide may be present in an amount ranging from a lower limit of one of 16.0, 16.5, 17.0, 17.5, 18.0, 18.5, 19.0, 19.5, 20.0, 20.5, 21.0, 21.5, 22.0 and 22.5 wt % and an upper limit of one of 23.0, 23.5, 24.0, 24.5, 25.0, 25.5, 26.0, 26.5, 27.0, 27.5, 28.0, 28.5, 29.0, 29.5, and 30.0 wt %.

It is also envisioned that the hydration control agent and/or wetting agent described above with respect to the adjuvant composition, are not included in the adjuvant composition but are present in the herbicide composition (and thus adjuvated herbicide composition), and at the ranges described above.

### Methods

One or more embodiments of the present disclosure relate to a method for treating a plant, comprising the application onto the plant of an adjuvated herbicide composition comprising an agricultural adjuvant and at least one agrochemical active ingredient. As noted above, the adjuvated herbicide composition may be a tank-mix or a built-in formulation. While the tank-mix formulation is achieved when the adjuvant and active ingredient are mixed (with simultaneous combination with an aqueous diluent), the present disclosure is also directed to built-in formulations, which can be considered to be a concentrated adjuvated herbicide composition. In such embodiments, the concentrated adjuvated herbicide composition may be diluted with an aqueous diluent, typically with water, in a ratio of from 1:10 to 1:1000, more typically about 1:50 to about 1:200, to form an aqueous end use adjuvated herbicide composition

Specifically, in one or more embodiments, the adjuvated herbicide composition may be a tank-mix formulation. Such adjuvated herbicide composition are prepared by the user by tank mixing an adjuvant composition with an herbicide composition and diluting this mixture, usually with water, directly in a tank intended then for spreading the obtained adjuvated herbicide. Following the tank-mixing, the adjuvated herbicide composition may be applied onto a plant.

For a tank-mix formulation, the use rate of herbicide (including glufosinate salts, glyphosate salts, or dicamba) in the adjuvated herbicide that is sprayed onto plants is at an amount of up to 2.3 v/v %. For example, the use rate may range from a lower limit of any of 0.5, 0.6, 0.7, 0.8, 0.9, 1.0, 1.1, 1.2, or 1.3 v/v % to an upper limit of 1.4, 1.5, 1.6, 1.7, 1.8, 1.9, 2.0, 2.1, 2.2, or 2.3 v/v %, where any lower limit can be paired with any upper limit.

For a tank-mix formulation, the use rate of the adjuvant composition in the adjuvated herbicide that is sprayed onto plants is at an amount of up to 1 v/v %. In one or more embodiments, the use rate ranges from a lower limit of any of 0.02, 0.05, 0.1, 0.15, 0.2, 0.25, 0.3, 0.35, 0.4 or 0.45 v/v % to an upper limit of 0.5, 0.55, 0.6, 0.65, 0.7, 0.75, 0.8, 0.85, 0.9, 0.95 or 1.0 v/v %, where any lower limit can be paired with any upper limit.

For a built-in formulation, the use rate of the adjuvated herbicide composition that is sprayed onto plants is at an amount of up to 2.3 v/v %. For example, the use rate may range from a lower limit of any of 0.5, 0.6, 0.7, 0.8, 0.9, 1.0, 1.1, 1.2, or 1.3 v/v % to an upper limit of 1.4, 1.5, 1.6, 1.7, 1.8, 1.9, 2.0, 2.1, 2.2, or 2.3 v/v %, where any lower limit can be paired with any upper limit.

In one or more embodiments, the adjuvant composition and adjuvated herbicide composition may be substantially homogeneous in visual appearance. In one or more embodiments, the adjuvant composition and adjuvated herbicide composition may be in the form of a single liquid phase that is homogeneous, clear, and transparent in visual appearance.

In one or more embodiments, the adjuvant composition and adjuvated herbicide composition of the present disclosure may exhibit good storage stability. The criteria for assessing storage stability are the extent to which, upon quiescent standing for a given period of time under given environmental conditions, the composition remains substantially homogeneous in visual appearance, without visible separation into layers of mutually insoluble liquid phases, separation of liquid from a thickened formulation, or formation of any solid precipitate, and the composition substantially retains its rheological properties. In one or more embodiments, the adjuvant composition remains stable during storage at temperatures of from −16° C. to 54° C. for greater than or equal to 7 days, more typically for greater than or equal to 14 days, and even more typically for greater than or equal to 30 days. In one or more embodiments, the adjuvant composition remains stable during continuous freeze-thaw cycling for greater than or equal to 7 days, more typically for greater than or equal to 14 days, and even more typically for greater than or equal to 30 days, wherein one freeze-thaw cycle is from 25° to −20° C. performed within 24 h and consists of a four hour dwell at 25° C. −5° C. and −20° C.

### EXAMPLES

The following examples are merely illustrative and should not be interpreted as limiting the scope of the present disclosure.

### Materials

For all examples, choline chloride was obtained as a 75% solution (COA: 75-77% of choline chloride, pH9 (range from 6-9) from Taminco US LLC (A subsidiary of Eastman Chemical Company). A mixture of carboxy betaines (lauryl betaine and myristyl betaine), Mirataine® BB/FLA, as well as a sultaine, Mirataine® ASC, were obtained from Solvay.

For tank-mix formulations, the active ingredient, Liberty® 280 SL was manufactured by Bayer. Oregon Green 488 (Molecular Probes™2′,7′-Difluorofluorescein) was obtained from Fisher Scientific. Ammonium sulfate (≥99.0%, ACS) was obtained from VWR.

For built-in formulations, the active ingredient, a 50% solution of glufosinate ammonium (technical grade), was obtained from BASF. Triton CG50 was obtained from Dow Chemicals. 1-methoxy-2-propanol (≥99.5% purity) was obtained from Sigma Aldrich. Sodium hydroxide pellets (ACS grade) was obtained from Fisher.

### Methods

Confocal microscopic images were acquired to monitor the penetration depth of actives with Oregon Green 488 as a fluorescent marker. Samples for the penetration test were prepared in 342 ppm hard water using the active ingredient (Liberty®) at 1, 1.2, and 1.5 v/v %, the adjuvant from 0.01−1 v/v %, and Oregon Green 488 at 0.5 mg/mL.

The test was done using model surface (Parafilm M) placed on the microscopy glass slides. 1 μL droplet of the formulation was placed on the Parafilm and the glass slides were transferred into a humidity-controlled chamber with a relative humidity (RH) of 35% and a temperature of 32° C. for 1 h. After 1h, the droplet spots were washed with 2 mL of DI water. After the wash, the droplet of DI water was placed on surface and covered with microscopy cover slip, followed by placing sample under the confocal microscope. The scan depth for each image was set at 30.14 μm. The obtained images were processed with MatLab to quantify the depth coming from the fluorescent signal observed inside the Parafilm.

### Preparation of Agricultural Adjuvant Composition

The agricultural adjuvant compositions were prepared by mixing Mirataine® BB/FLA (B) in water with 75% solution of choline chloride (C) at 1:1 (B:C), 2:1 (B:C), and 1:2 (B:C) and wt % ratios. The mixing was done using an overhead stirrer.

### Preparation of Adjuvated Herbicide Composition

The tank-mix adjuvated herbicide was prepared by manually mixing Liberty® 280 SL with the adjuvant compositions and 342 ppm hard water by 10 inversions.

The built-in adjuvated herbicide was prepared by directly mixing glufosinate ammonium with the adjuvant composition. The built-in formulation at specific use rate was then directly mixed into 342 ppm hard water by 10 manual inversions.

### Example 1

### Tank-Mix Adjuvated Herbicide Compositions

A variety of different tank-mix adjuvated herbicide compositions with the agrochemical active ingredient and with/without agricultural adjuvants were prepared. The make-up of the tank-mix adjuvated herbicide compositions are listed in Table 1.

TABLE 1

| | | | Carboxy | Choline | | |
|---|---|---|---|---|---|---|
| | | | Betaines | chloride | Sultaine | |
| | | Adjuvant | (in | (in | (in | |
| | Liberty ® | use | Betaines: | Betaines: | Betaines: | Ammonium |
| | 280SL % | rate % | choline | choline | choline | sulfate |
| Sample | (v/v) | (v/v) | chloride) | chloride) | chloride) | (wt %) |
| 1 (CE) | 1.0 | 0 | 0 | 0 | 0 | 0 |
| 2 (CE) | 1.2 | 0 | 0 | 0 | 0 | 0 |
| 3 (CE) | 1.5 | 0 | 0 | 0 | 0 | 0 |
| 4 (CE) | 1.0 | 0 | 0 | 0 | 0 | 2.4 |
| 5 (CE) | 1.2 | 0 | 0 | 0 | 0 | 2.4 |
| 6 (CE) | 1.5 | 0 | 0 | 0 | 0 | 2.4 |
| 7 | 1.5 | 0.5 | 0 | 1 | 3 | 0 |
| 8 | 1.0 | 0.5 | 2 | 1 | 0 | 0 |
| 9 | 1.0 | 0.06 | 2 | 1 | 0 | 2.4 |
| 10 | 1.2 | 0.5 | 2 | 1 | 0 | 0 |
| 11 | 1.2 | 0.4 | 2 | 1 | 0 | 2.4 |
| 12 | 1.5 | 0.5 | 2 | 1 | 0 | 0 |
| 13 | 1.5 | 0.5 | 1 | 1 | 0 | 0 |
| 14 | 1.5 | 0.5 | 1 | 2 | 0 | 0 |
| 15 | 1.5 | 1 | 1 | 0 | 0 | 0 |
| 16 | 1.5 | 1 | 0 | 1 | 0 | 0 |
| 17 | 1.5 | 0.06 | 2 | 1 | 0 | 2.4 |

The penetration depth at arid conditions (35% RH; 32° C. for the samples in Table 1 are provided in Table 2.

TABLE 2

| | | Penetration | |
|---|---|---|---|
| | | Depth | |
| | Penetration | standard | |
| | Depth | deviation | |
| Sample | (μm) | (μm) | T-test |
| 1 (CE) | 5.8 | 1.6 | NA |
| 2 (CE) | 6.1 | 1.6 | NA |
| 3 (CE) | 6.4 | 2.4 | NA |
| 4 (CE) | 7.4 | 2.3 | NA |
| 5 (CE) | 6.3 | 1.2 | NA |
| 6 (CE) | 6.8 | 2.1 | NA |
| 7 | 7.4 | 1 | Statistically same as #3 |
| 8 | 8.0 | 2.5 | Statistically different from |
| | | | #1, 2, and 3 |
| 9 | 9.2 | 1.7 | Statistically different from |
| | | | #4 and 6 |
| 10 | 8.8 | 2.5 | Statistically different from |
| | | | #1, 2, and 3 |
| 11 | 8.4 | 2.4 | Statistically different from |
| | | | #1, 2, and 3 |
| 12 | 12.8 | 4.0 | Statistically different from |
| | | | #1, 2, and 3 |
| 13 | 11.4 | 5.0 | Statistically different from |
| | | | #1, 2, and 3 |
| 14 | 12.5 | 4.4 | Statistically different from |
| | | | #1, 2, and 3 |
| 15 | ND | ND | NA |
| 16 | 7.2 | 2.1 | Statistically same as #3 |
| 17 | 8.7 | 1.9 | Statistically different from |
| | | | #4, 5, and 6 |

ND - depth quantitation not possible
NA - T-test not applicable

As shown in Table 2, agricultural adjuvant compositions of samples 8-14 and 17 of the present disclosure led to a statistically significant improvement in penetration depth.

In the comparative control examples (samples 1-6), the Liberty® 280 SL without adjuvants had penetrations depth independent of the formulation use rate and presence of AMS. Specifically, in case of Liberty® 280 SL at use rate of 1.5, 1.2 and 1% v/v, the average value of the depth was ˜6.4, 6.1 and 5.8 μm, respectively. In the presence of AMS, the average penetration depth was similar and was in the range from 6.3-7.4 μm (Table 2).

Addition of the carboxy betaines and choline adjuvants (samples 8-14 and 17) showed statistically significant increase in penetration depth, regardless of the AMS presence. Substitution of carboxy betaine with sultaine (sample 7) did not improve the penetration. Furthermore, sample 16 shows that addition of choline chloride alone also does not improve the penetration depth. In case of betaine only (sample 15), the definitive conclusion on the effect of carboxy betaines on penetration could not be reach due to lack of reliably quantifiable fluoresce signal inside the surface.

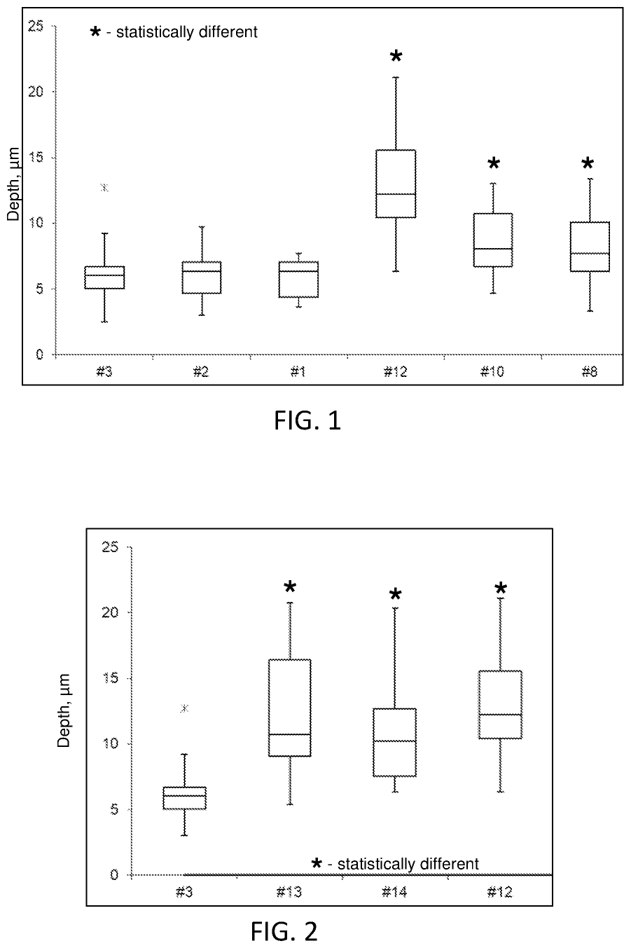

The improvement in penetration observed in the presence of adjuvant were dependent on the adjuvant and Liberty®280 SL use rates, and presence of AMS. The highest penetration depth is observed in samples 12-14 at 0.5% v/v use rate of the adjuvants with Liberty®280 SL at 1.5% v/v. Indeed, the penetration depth increased from 6.4 μm (Liberty®280 SL alone) to 12.8 μm, 12.4 μm, 11.4 μm (Samples 12-14). Decrease in use rate of Liberty® from 1.5% to 1.2 and 1% v/v, while keeping the adjuvant use rate at 0.5% v/v, resulted in slight decrease in the depth of penetration. In spite of the slight depth decrease, the penetration in the presence of adjuvant is statistically better than Liberty® alone, as shown in FIG. 1 which illustrates the penetration depth for different Liberty® use rates without adjuvants (samples 1-3), as compared to inventive samples including adjuvant at 2:1 B:C (samples 8, 10, and 12).

The benefits of 2:1 B:C adjuvant was also tested in the presence of 2.4 wt % ammonium sulfate (AMS), which is typically applied together with Liberty®280 SL. As seen from samples 9, 11 and 17, addition of the adjuvant in the presence of AMS also improves the penetration depth, as shown in FIG. 2.

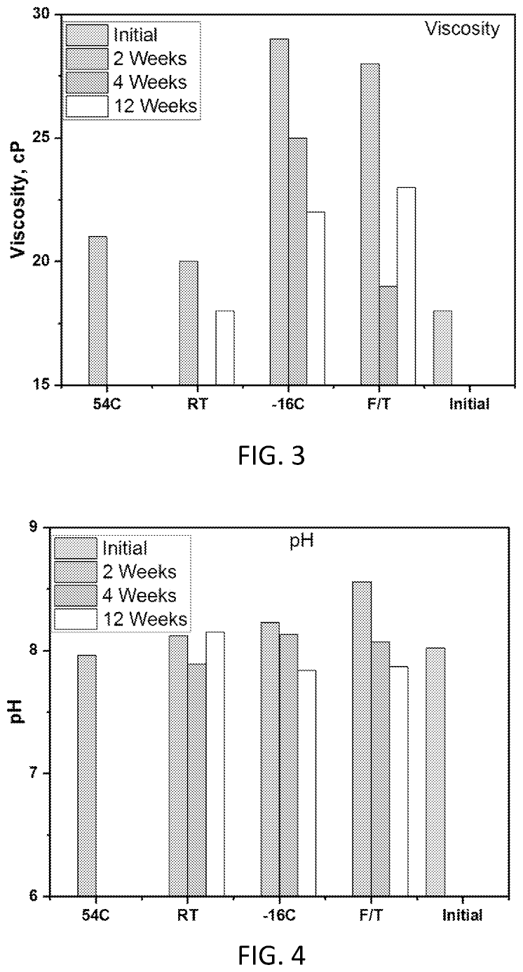

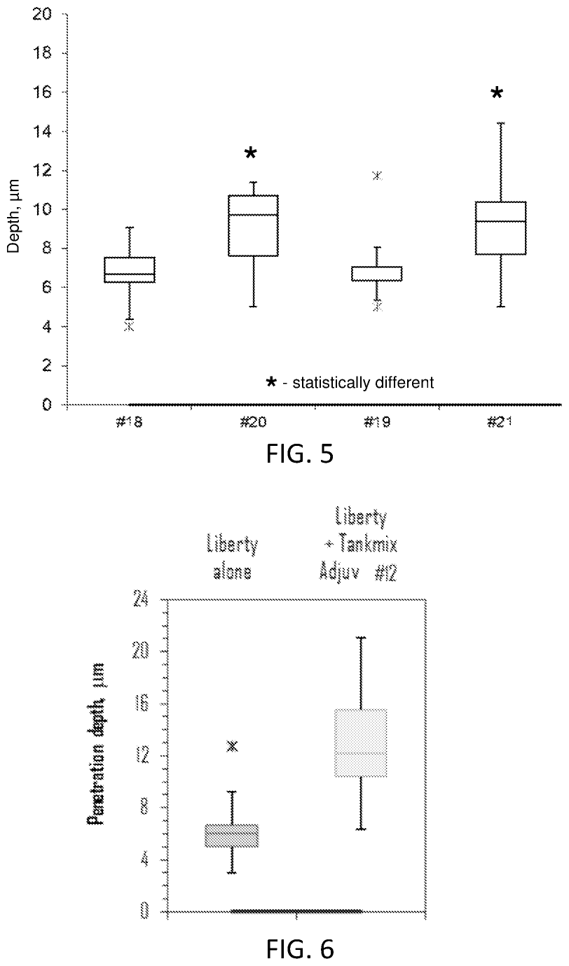

To assess the stability of the adjuvant composition (without Liberty®), a 2:1 B:C adjuvant composition was subjected to 2 weeks at 54° C., which showed that the adjuvant had no phase separation and remained a clear non-viscous liquid over the stability study. The same adjuvant showed such stability at −16° C., RT, and freeze-thaw (F/T) cycles (of 24 hours) for 2 weeks, 4 weeks, and even 12 weeks. At 54° C., stability was done for 2 weeks only and the adjuvant remained stable after 2 weeks. Furthermore, the adjuvant did not freeze at −16° C. and also remained an easy flowing liquid with low viscosity (˜29 cP at 30 rpm/LV2). FIG. 3 illustrates the viscosity stability of the 2:1 B:C adjuvant at various temperatures over a period of time. Specifically, FIG. 4 illustrates that the adjuvant remains a flowing liquid, including at −16° C. following freeze-thaw cycles. FIG. 5 illustrates the pH stability of the 2:1 B:C adjuvant at various temperatures over a period of time. As shown in FIGS. 4-5, the 2:1 B:C adjuvant composition remains stable at elevated and low temperatures for at least 12 weeks.

### Example 2

### Built-In Adjuvated Herbicide Formulation

Built-in adjuvated herbicide formulation with SLES and 1% of 2:1 B:C adjuvant with and without ammonium sulfate were prepared. Table 3 (below) shows the composition of the adjuvated herbicide formulation without ammonium sulfate.

TABLE 3

| Component | Weight (%) |
|---|---|
| Glufosinate ammonium (50%) | 45.37 |
| Water | 10.46 |
| 2M NaOH | 3.7 |
| 2:1 BC | 1.01 |
| 1-methoxy-2-propanol | 2.78 |
| Triton CG50 | 11.48 |
| SLES | 25.2 |

The formulations with and without (control) the adjuvant were evaluated using penetration test. The control formulations had no adjuvant but had the same surfactant composition. The formulations tested are listed in Table 4. The test was performed in arid conditions (32° C.; 37(1) % RH) at use rate of 1.5% v/v. The testing was performed with and without AMS presence.

TABLE 4

| | | Use rate of built-in | % of Ammonium sulfate in |
|---|---|---|---|
| Sample | % of Adjuvant | (%, v/v) | built-in (wt %) |
| 18 (CE) | 0 | 1.5 | 0 |
| 19 (CE) | 0 | 1.5 | 2.4 |
| 20 | 1 | 1.5 | 0 |
| 21 | 1 | 1.5 | 2.4 |

As shown in Table 5 below and illustrated in FIG. 5, the formulations with built-in 1% of the adjuvant showed improved penetration as compared to the formulation without the adjuvant. Furthermore, the penetration depth remained the same with and without AMS. The penetration depth at arid conditions of the samples in Table 3 are provided in Table 5.

TABLE 5

| | | Penetration | |
|---|---|---|---|
| | | Depth | |
| | Average | standard | |
| | Penetration | deviation | |
| Sample | Depth (μm) | (μm) | T-test results |
| 18 (CE) | 6.9 | 1.3 | n/a |
| 19 (CE) | 7.1 | 1.5 | n/a |
| 20 | 9.3 | 2.7 | Statistically different from #1 |
| 21 | 9.2 | 1.9 | Statistically different from #2 |

### Example 3

### Greenhouse Results

The efficacy of Liberty and Liberty tank-mix with adjuvant sample #12 was tested in Greenhouse on Velvetleaf (Abutilon theophrasti). The relative humidity was 35% or below and temperature was 80-90° F. during the day over trial durations. The efficacy was assessed at 1, 3, 5, 7, 14, 21 and 28 days after spraying by comparing treated plants with untreated control. The Liberty use rate in the trials was 29 oz. The adjuvant sample #12 was selected as best candidate according to the penetration data (in FIG. 6) obtained from model surfaces, where the adjuvant provided significant improvement in the penetration depth vs Liberty alone.

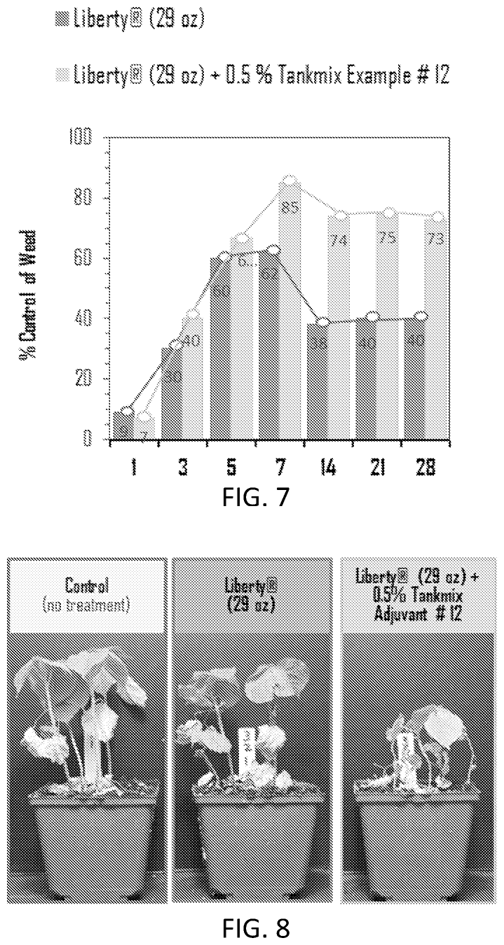

As seen from FIG. 7, Liberty had difficulties to control Velvetleaf and the weed was able to start regrowth after 2 weeks from application date (the % of control decreased from 62 to 38%). Contrarily, addition of adjuvant sample #12 increased herbicide ability to control the weed up to 28 days. The Velvetleaf pictures presented in FIG. 8 shows example of untreated control, Liberty and Liberty+adjuvant sample 12 after 21 days.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. An agricultural adjuvant composition for herbicides, comprising:
at least one betaine compound; and
choline chloride,
wherein a ratio of the at least one betaine compound relative to the choline chloride ranges from 1:8 to 8:1.

2. The agricultural adjuvant composition of claim 1, wherein the at least one betaine compound comprises a mixture of betaine compounds.

3. The agricultural adjuvant composition of claim 2, wherein the mixture of betaines comprises at least two carboxy betaines.

4. The agricultural adjuvant composition of claim 3, where the mixture of betaines comprises lauryl betaine and myristyl betaine.

5. The agricultural adjuvant composition of claim 1, further comprising an alkyl ether sulfate as a wetting agent.

6. (canceled)

7. The agricultural adjuvant composition of claim 5, wherein the alkyl ether sulfate is sodium lauryl ether sulfate.

8. The agricultural adjuvant composition of claim 1, further comprising ammonium sulfate as a hydration control agent.

9. (canceled)

10. The agricultural adjuvant composition of claim 1, wherein no more than 30 wt % of the adjuvant composition is a component other than betaines, choline chloride, and water.

11. An adjuvated herbicide composition comprising:
agricultural adjuvant composition of claim 1; and
an effective amount of at least one agrochemical active ingredient;
wherein the agricultural adjuvant composition increases penetration of the at least one agrochemical active ingredient into a plant.

12. The adjuvated herbicide composition of claim 11, further comprising an alkyl ether sulfate as a wetting agent.

13. (canceled)

14. The adjuvated herbicide composition of claim 11, further comprising a hydration control agent.

15. The adjuvated herbicide composition of claim 11, wherein the at least one agrochemical active ingredient comprises dicamba.

16. The adjuvated herbicide composition of claim 11, wherein the at least one agrochemical active ingredient is a glufosinate or a glyphosate.

17. A method for treating a plant, comprising applying onto the plant the adjuvated herbicide composition of claim 11.

18. The method of claim 17, further comprising:
providing an adjuvant composition comprising choline chloride and at least one betaine and tank mixing and diluting the adjuvant composition with at least one agrochemical active ingredient to form an adjuvated herbicide composition.

19. The method of claim 17, further comprising:
providing a concentrated adjuvated herbicide composition comprising at least one active ingredient, choline chloride and at least one betaine and
diluting the concentrated adjuvated herbicide composition to form the adjuvated herbicide composition that is applied onto plants.

20. The method of claim 17, wherein at least one agrochemical active ingredient is present at an amount up to 2.3% v/v of the adjuvated herbicide composition.

21. The method of claim 17, wherein the adjuvant composition is present at an amount up to 1% v/v of the adjuvated herbicide composition.

22. A method for increasing the penetration of agrochemical active ingredient into a plant, comprising:
mixing an agricultural adjuvant composition of claim 1 with at least one agrochemical active ingredient to form an adjuvated herbicide composition comprising the agricultural adjuvant composition and an effective amount of at least one agrochemical active ingredient;
wherein the agricultural adjuvant composition increases penetration of the at least one agrochemical active ingredient into a plant.

23. The method of claim 22, further comprising: applying onto the plant the adjuvated herbicide composition.
